(19) United States
(12) Patent Application Publication
(10) Pub. No.: US 2023/0124958 A1
(43) Pub. Date: Apr. 20, 2023

(54) DATA REPORT RATE ADJUSTMENT METHOD

(71) Applicant: Primax Electronics Ltd., Taipei (TW)

(72) Inventors: Shi-Jie Zhang, Taipei (TW); Che-Yen Huang, Taipei (TW); Ying-Che Tseng, Taipei (TW); Huei-Jung Lee, Taipei (TW)

(21) Appl. No.: 17/545,810

(22) Filed: Dec. 8, 2021

(30) Foreign Application Priority Data
Oct. 15, 2021 (TW) 110138422

(51) Int. Cl. G06F 13/10; G06F 9/46

(52) U.S. Cl. CPC G06F 13/102; G06F 9/466

(57) ABSTRACT

A data report rate adjustment method for use between a computer host and a peripheral device is provided. According to the actual workload level and the hardware operating performance of the computer host and/or the information about the built-in application software, the data report rate is intelligently or dynamically adjusted according to the built-in default value or the user-defined value.

### FIELD OF THE INVENTION

The present invention relates to a data report rate adjustment method, and more particularly to a data report rate adjustment method for use between a computer host and a peripheral device.

### BACKGROUND OF THE INVENTION

In the information field, a data report rate is usually used to represent the speed or the frequency that a HID (human interface device) type peripheral device such as a mouse, a keyboard or a voice-controlled sound input device reports a data to a computer host. For example, if the data report rate of a HID-type peripheral device in a Windows operating system is 250 Hz, the HID-type peripheral device transfers 250 reports of data to the computer host every second. In other words, the computer host receives one data from the HID-type peripheral device very 4 ms on average.

At present, for professional computer gamers or computer creators, the easiest input peripheral device to be operated is the mouse. Nowadays, in order to improve the accuracy, the smoothness and the control feel of operating the mouse, the method of increasing the data report rate is usually adopted. For example, a mouse capable of reporting 10000 data per second has been introduced into the market. That is, the computer host receives one data every 100 μs on average. Under this circumstance, up to 10,000 interrupt notifications per second are generated.

Since the amount of data to be reported is tool huge and the data report rate is too high, some drawbacks occur. For example, if the hardware performance of the computer host is not good or the computer host is in a high load operation state, the workload of the computer host is further increased. Under this circumstance, the possibility that the computer host is unable to meet this requirement of high data report rate will increase. Moreover, it is a power-consuming work for the peripheral device to be operated at the high data report rate.

In order to overcome the drawbacks of the conventional technologies, there is a need of providing an intelligent or dynamic data report rate adjustment method for use between a computer host and a peripheral device.

### SUMMARY OF THE INVENTION

An object of the present invention provides a data report rate adjustment method for use between a computer host and a peripheral device. The data report rate can be dynamically adjusted according to the actual workload level and the hardware operating performance of the computer host and the peripheral device.

An object of the present invention provides a data report rate adjustment method for use between a computer host and a peripheral device. The data report rate can be dynamically adjusted according to the actual workload level and the hardware operating performance of the computer host and the operating type of a built-in software.

In accordance with an aspect of the present invention, a data report rate adjustment method for use between a computer host and a peripheral device is provided. The data report rate adjustment method includes the following steps. Firstly, a step (a) is performed to judge whether a content of a software operating list is launched and served as a criterion for adjusting a data report rate of the peripheral device. In a step (b), if a judging result of the step (a) indicates that the content of the software operating list is launched and served as the criterion for adjusting the data report rate of the peripheral device, judge whether a designated data report rate notification is generated according to an information of at least one application software in the software operating list and served as the criterion for adjusting the data report rate of the peripheral device. In a step (c), the designated data report rate notification is generated according to the information of at least one application software in the software operating list, a designated data report rate adjustment process is performed according to the designated data report rate notification, and the step (a) is performed again. In a step (d), if the judging result of the step (a) indicates that the content of the software operating list is not launched or a judging result of the step (b) indicates that the designated data report rate notification is not generated to be served as the criterion for adjusting the data report rate of the peripheral device, at least one of a peripheral device operating information, a peripheral device input information, a hardware performance indication information and a hardware real-time load information is automatically collected. In a step (e), a dynamic data report rate notification is generated according to a frequency of using the at least one application software in the software operating list by a user and/or according to at least one of the peripheral device operating information and the peripheral device input information, the hardware performance indication information and the hardware real-time load information, performing a dynamic data report rate adjustment process according to the dynamic data report rate notification, and the step (a) is performed again.

In the step (a), the content of the software operating list contains the information of the at least one application software that in installed in the computer host and operated and used through the peripheral device.

In the step (b), the designated data report rate notification is previously set in the software operating list according to a function property of the at least one application software, and the designated data report rate notification is related to at least one fixed data report rate corresponding to the at least one application software.

In an embodiment, while the designated data report rate adjustment process in the step (c) is performed, the designated data report rate notification is transmitted from the computer host to the peripheral device and the data report rate of the peripheral device is adjusted automatically according to the designated data report rate notification, or the computer host generates the designated data report rate notification to prompt the user and the user manually adjusts the data report rate of the peripheral device according to the designated data report rate notification.

In an embodiment, the data report rate of the peripheral device is manually adjusted by the user through a single key or a key combination of the peripheral device in response to the designated data report rate notification. The single key or the key combination is manually and repeatedly pressed to switch a group of plural different default data report rates until one of the plural default data report rate is selected, or the single key or the key combination is manually and repeatedly pressed to switch plural combinations of the group of plural different default data report rates and a group of plural different default dots per linear inch (DPI) values until one of the plural combinations of the group of plural different default data report rates and the group of plural different default DPI values is selected. The key combination is a combination of a DPI key and a right key of a mouse, a combination of a lateral key and a roller key of a mouse, or a combination of a function key and a numeric key of a keyboard.

In an embodiment, while the dynamic data report rate adjustment process in the step (e) is performed, the dynamic data report rate notification is transmitted from the computer host to the peripheral device and the data report rate of the peripheral device is adjusted automatically according to the dynamic data report rate notification, or the computer host generates the dynamic data report rate notification to prompt the user and the user manually adjusts the data report rate of the peripheral device according to the dynamic data report rate notification.

In an embodiment, the data report rate of the peripheral device is manually adjusted by the user through a single key or a key combination of the peripheral device in response to the dynamic data report rate notification. The single key or the key combination is manually and repeatedly pressed to switch a group of plural different default data report rates until one of the plural default data report rate is selected, or the single key or the key combination is manually and repeatedly pressed to switch plural combinations of the group of plural different default data report rates and a group of plural different default dots per linear inch (DPI) values until one of the plural combinations of the group of plural different default data report rates and the group of plural different default DPI values is selected. The key combination is a combination of a DPI key and a right key of a mouse, a combination of a lateral key and a roller key of a mouse, or a combination of a function key and a numeric key of a keyboard.

In the step (d), the peripheral device operating information is an operating habit information related to a habit of the user to operate the peripheral device and at least contains a frequently-used key information and an operating time information, or the peripheral device input information is an input data information related to the peripheral device and contains at least one of a key data input data information, a sensor data input information, a roller movement data input information and a lighting effect data input information, or the hardware performance indication information is related to a hardware component score of the computer host and contains at least one of a central processing unit (CPU) clock speed score, a memory capacity score, a solid state drive (SSD) capacity score and a hardware accelerator card score, or the hardware real-time load information is related to a workload level of the central processing unit of the computer host in a real-time operation.

In an embodiment, after the data report rate of the peripheral device has been adjusted in the step (c) or the step (e), an information of the adjusted data report rate is transmitted from the peripheral device to the computer host and a specified notification message is provided to notify the user, and then the computer host performs the step (a) again.

In an embodiment, the specified notification message is a text message shown in an on-screen display (OSD) manner, a light effect message generated in a light emitting diode (LED) display manner, an/or a sound effect notification message.

In an embodiment, a data report rate intelligent adjustment software is installed in the computer host, and the data report rate intelligent adjustment software works with the computer host and a microprocessor of the peripheral device to implement the step (a), the step (b), the step (c), the step (d) and the step (e).

In an embodiment, the data report rate intelligent adjustment software at least contains the software operating list and a profile, which are established in the data report rate intelligent adjustment software in a built-in manner or previously set in the data report rate intelligent adjustment software by the user. The profile at least contains a group of plural different default data report rates, or the profile at least contains plural combinations of the group of plural different default data report rates and a group of plural different default dots per linear inch (DPI) values.

In an embodiment, the data report rate intelligent adjustment software detects operation status or system configuration statuses to collect at least one of the peripheral device operating information, the peripheral device input information, the hardware performance indication information and the hardware real-time load information.

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1A and 1B illustrate a flowchart of a data report rate adjustment method according to an embodiment of the present invention;

FIGS. 2A, 2B and 2C illustrate three implementation examples of using the data report rate adjustment method according to the embodiment of the present invention;

FIG. 3 illustrates a flowchart of establishing the combinations of three different default data report rates and three different default DPI values in a profile in a built-in manner;

FIG. 4A illustrates a flowchart of a method for presetting the profile in the data report rate intelligent adjustment software by the user; and

FIG. 4B illustrates a flowchart of a method for allowing the user to switch the operation of the peripheral device through the profile established by the method of FIG. 4A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

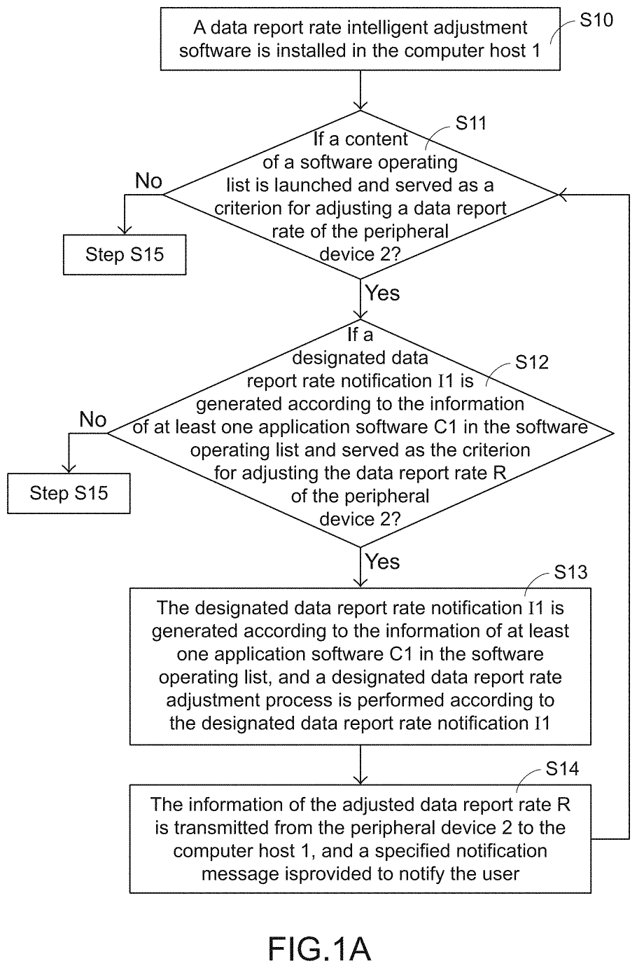

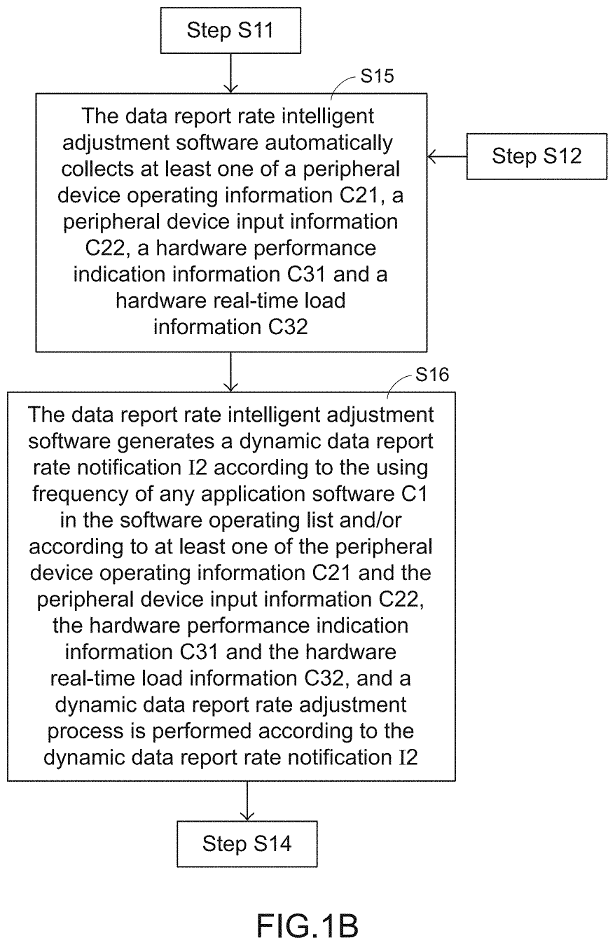

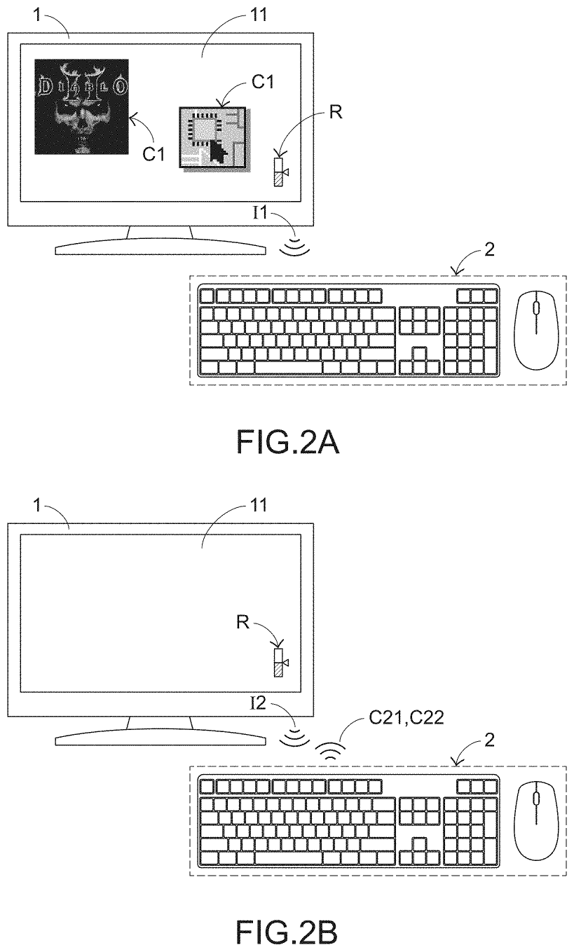

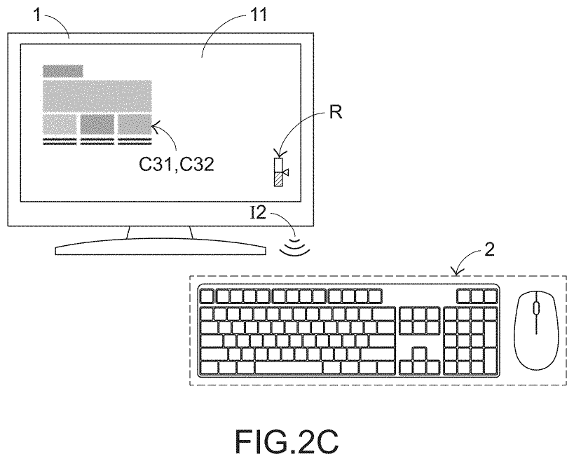

The present invention provides a data report rate adjustment method. For well understanding the concepts of the present invention, a flowchart of the data report rate adjustment method will be described as follows. FIGS. 1A and 1B illustrate a flowchart of a data report rate adjustment method according to an embodiment of the present invention. Three implementation examples of using the data report rate adjustment method between a computer host 1 and a peripheral device 2 will be illustrated with reference to FIGS. 2A, 2B and 2C.

The computer host 1 is a personal terminal computer device (e.g., a notebook computer, a desktop host, or any other appropriate handheld computer device) or a cloud computer device. The peripheral device 2 is a HID (human interface device) type peripheral device such as a mouse, a keyboard or a voice-controlled sound input device. For well understanding the present invention, a mouse and/or a keyboard will be taken as the example of the peripheral device. It is noted that the example of the peripheral device is not restricted.

The data report rate adjustment method comprises the following steps.

Firstly, in a step S10, a data report rate intelligent adjustment software is installed in the computer host 1.

The data report rate intelligent adjustment software can work with the computer host 1 and the peripheral device 2 to implement the concepts of the present invention.

In an embodiment, the data report rate intelligent adjustment software is built in the computer host 1. Alternatively, the data report rate intelligent adjustment software is sold with the peripheral device 2, and then the data report rate intelligent adjustment software is installed in the computer host 1 by the user.

Then, in a step S11, the data report rate intelligent adjustment software is executed to judge whether a content of a software operating list is launched and served as a criterion for adjusting a data report rate R of the peripheral device 2.

The software operating list is established in the data report rate intelligent adjustment software in a built-in manner or previously set in the data report rate intelligent adjustment software by the user. An example of the content of the software operating list is illustrated with reference to FIG. 2A. FIG. 2A illustrates a first implementation example of using the data report rate adjustment method. The content of the software operating list contains the information of at least one application software C1 that is being executed through the operation and use of the peripheral device. An example of the application software C1 includes but is not limited to a word processing software, an operating system software (such as an operating system or a browser), a social chat software, a graphics software, or any other appropriate application software.

The establishment of the software operating list is helpful to adjust the data report rate R of the peripheral device 2 in the subsequent steps. In an embodiment, the current data report rate R of the peripheral device 2 can be shown on a display screen 11 of the computer host 1.

If the judging result of the step S11 indicates that the content of the software operating list is launched and served as a criterion for adjusting the data report rate R of the peripheral device 2, a step S12 is performed. In the step S12, the data report rate intelligent adjustment software judges whether a designated data report rate notification I1 is generated according to the information of at least one application software C1 in the software operating list and served as the criterion for adjusting the data report rate R of the peripheral device 2.

Please refer to FIG. 2A again. The designated data report rate notification I1 is previously set in the software operating list according to a function property of the at least one application software C1. In addition, the designated data report rate notification I1 is related to at least one fixed data report rate corresponding to the at least one application software C1.

For example, when the general social chat software is executed, the workload of a central processing unit (not shown) of the computer host 1 in the real-time operation is not too large. Due to the function property of this software, the corresponding data report rate can be designated as a default fixed data report rate (e.g., 100 Hz). In addition, during the execution of this software, it is not necessary to dynamically adjust the data report rate R of the peripheral device 2. In contrast, the function properties of some game software are related to the quick and precise operations. During the process of operating the peripheral device 2 to play the game, it is not suitable to reduce the data report rate. In this situation, the data report rate of the peripheral device corresponding to the game software can be designated as a fixed high data report rate (e.g., 4000 Hz). Consequently, the user can operate the peripheral device to play the game more smoothly and precisely.

In some embodiments, the data report rates of the peripheral device 2 corresponding to some special application software of the at least one application software C1 are not designated as the fixed high data report rates. In this situation, the data report rate intelligent adjustment software dynamically adjusts the data report rate R of the peripheral device 2 according to the using frequencies of the specific application software used by the user. The detailed method will be described in steps S15 and S16 later.

As mentioned above, the step S12 will be performed according to the content of the software operating list is launched and served as a criterion for adjusting the data report rate R of the peripheral device 2. In other words, during the subsequent step of adjusting the data report rate R of the peripheral device 2, the content of the software operating list is involved in the comprehensive judgment of the data report rate intelligent adjustment software.

If the judging condition of the step S12 is satisfied, a step S13 is performed. In the step S13, the data report rate intelligent adjustment software generates the designated data report rate notification I1 according to the information of at least one application software C1 in the software operating list, and a designated data report rate adjustment process is performed according to the designated data report rate notification I1.

Please refer to FIG. 2A again. As mentioned above, the designated data report rate notification I1 is related to the at least one fixed data report rate corresponding to the at least one application software C1, and the at least one fixed data report rate is required in the subsequent step of adjusting the data report rate R of the peripheral device 2. Hereinafter, at least two implementation examples of the designated data report rate adjustment process will be described.

In a first implementation example, the designated data report rate notification I1 is transmitted from the computer host 1 to the peripheral device 2 directly. According to the designated data report rate notification I1, the data report rate R of the peripheral device 2 is adjusted automatically.

In a second implementation example, after the computer host 1 generates the designated data report rate notification I1 to prompt the user, the user manually adjusts the data report rate R of the peripheral device 2. For example, according to the designated data report rate notification I1, the information about the at least one fixed data report rate to be adjusted is shown on the display screen 11. Consequently, the user can realize the designated target of the data report rate to be adjusted. Then, the user can adjust the data report rate R of the peripheral device 2 through a single key or a key combination. In an embodiment, the single key or the key combination is manually and repeatedly pressed to switch a group of plural different default data report rates until the selected default data report rate matches the at least one fixed data report rate. Especially, in case that the peripheral device 2 is a mouse, the dots per linear inch (DPI) value representing the resolution of the mouse can be also taken into consideration. In this case, the single key or the key combination is manually and repeatedly pressed to switch the combinations of a group of plural different default data report rates and a group of plural different default DPI values until the selected default data report rate matches the at least one fixed data report rate. After the selected default data report rate matches the at least one fixed data report rate, the data report rate R of the peripheral device 2 is adjusted accordingly.

In an embodiment, the group of plural different default data report rates or the combinations of the group of plural different default data report rates and the group of plural different default DPI values are established in a profile. In addition, the profile is established in the data report rate intelligent adjustment software in a built-in manner or previously set in the data report rate intelligent adjustment software by the user.

Preferably but not exclusively, the key combination is a combination of a DPI key and a right key of a mouse, a combination of a lateral key and a roller key of a mouse, or a combination of a function key and a numeric key of a keyboard.

After the step S13, a step S14 is performed. In the step S14, the information of the adjusted data report rate R is transmitted from the peripheral device 2 to the computer host 1, and a specified notification message is provided to notify the user. Then, the computer host 1 performs the step S11 again.

Preferably but not exclusively, the specified notification message is a text message shown in an on-screen display (OSD) manner, a light effect message generated in a light emitting diode (LED) display manner, an/or a sound effect notification message.

The step S14 is optionally or completely done according to the practical requirements. For example, in some embodiments, the procedure of providing the specified notification message to notify the user by the peripheral device 2 is omitted. That is, the information of the adjusted data report rate R is transmitted from the peripheral device 2 to the computer host 1 directly, and then the computer host 1 performs the step S11 again.

If the judging result of the step S11 indicates that the content of the software operating list is not launched or the judging result of the step S12 indicates that the content of the software operating list is launched but the designated data report rate notification I1 is not generated as the criterion for adjusting the data report rate R of the peripheral device 2, the step S15 is performed. In the step S15, the data report rate intelligent adjustment software automatically collects at least one of a peripheral device operating information C21, a peripheral device input information C22, a hardware performance indication information C31 and a hardware real-time load information C32. Preferably, the data report rate intelligent adjustment software detects operation status or system configuration statuses of the computer host 1 and the peripheral device 2 to automatically collect at least one of the peripheral device operating information C21, the peripheral device input information C22, the hardware performance indication information C31 and a hardware real-time load information C32.

Hereinafter, two other implementation examples of using the data report rate adjustment method will be illustrated with reference to FIGS. 2B and 2C.

In the implementation example of FIG. 2B, the peripheral device operating information C21 is an operating habit information related to the habit of the user to operate the peripheral device. For example, the operating habit information at least includes a frequently-used key information and an operating time information. Moreover, the peripheral device input information C22 is an input data information related to the peripheral device 2.

In the implementation example of FIG. 2C, the hardware performance indication information C31 is related to a hardware component score of the computer host 1. The hardware component score contains at least one of a central processing unit (CPU) clock speed score, a memory capacity score, a solid state drive (SSD) capacity score and a hardware accelerator card score. In addition, the hardware real-time load information C32 is related to the workload level of the central processing unit of the computer host 1 in a real-time operation.

Moreover, the peripheral device operating information C21 is not restricted to the frequently-used key information about plural keys of the peripheral device 2 that are frequently used by the user, or the peripheral device operating information C21 is not restricted to the operating time information about the time period of operating the peripheral device 2 by the user. It is noted that any other appropriate operating habit information related to the peripheral device 2 (e.g., the movement range of operating the peripheral device 2) is feasible.

In case that the peripheral device 2 is a mouse, the peripheral device input information C22 contains at least one of a mouse sensor data input information, a position-related input data information (e.g., a mouse roller data information, a left side data information, a right side data information or a lateral side data information), a function key-related input data information (e.g., a key data input data information or a roller movement data input information) and any other appropriate hardware information (e.g., a lighting effect data input information).

The hardware performance indication information C31 is not restricted to at least one of the CPU clock speed score, the memory capacity score, the SSD capacity score and the hardware accelerator card score. In some embodiments, the hardware performance indication information C31 contains various other hardware performance scores related to the computer host 1.

In other words, the hardware performance information in any of the peripheral device operating information C21, the peripheral device input information C22, the hardware performance indication information C31 and the hardware real-time load information C32 and associated with the data report rate R of the peripheral device 2 will be collected by the data report rate intelligent adjustment software.

Moreover, in the step S12 and as shown in FIG. 2A, the using frequencies of the specific application software C1 used by the user are also collected by the data report rate intelligent adjustment software. Consequently, the using frequencies of the specific application software C1 are dynamically added to the subsequent evaluation step of adjusting the data report rate R of the peripheral device 2.

After the step S15, the step S16 is performed. In the step S16, the data report rate intelligent adjustment software generates a dynamic data report rate notification 12 according to the using frequency of at least one application software C1 in the software operating list and/or according to at least one of the peripheral device operating information C21 and the peripheral device input information C22, the hardware performance indication information C31 and the hardware real-time load information C32, and a dynamic data report rate adjustment process is performed according to the dynamic data report rate notification 12. Then, the step S14 is performed again.

As mentioned above, the dynamic data report rate notification 12 contains an adjustment information for the peripheral device 2 to perform the dynamic data report rate adjustment process. Hereinafter, at least two implementation examples of the dynamic data report rate adjustment process will be described. In a first implementation example, the dynamic data report rate notification 12 is transmitted from the computer host 1 to the peripheral device 2 directly. According to the dynamic data report rate notification 12, the data report rate R of the peripheral device 2 is adjusted automatically.

In a second implementation example, after the computer host 1 generates the dynamic data report rate notification 12 to prompt the user, the user manually adjusts the data report rate R of the peripheral device 2. For example, in response to the dynamic data report rate notification 12, the information about the data report rate to be adjusted is shown on the display screen 11. Consequently, the user can realize the target of the data report rate to be adjusted. Then, the user can adjust the data report rate R of the peripheral device 2 through a single key or a key combination. In an embodiment, the single key or the key combination is manually and repeatedly pressed to switch a group of plural different default data report rates until the selected default data report rate matches the at least one fixed data report rate. Especially, in case that the peripheral device 2 is a mouse, the dots per linear inch (DPI) value representing the resolution of the mouse can be also taken into consideration. In this case, the single key or the key combination is manually and repeatedly pressed to switch the combinations of a group of plural different default data report rates and a group of plural different default DPI values until the selected default data report rate matches the at least one fixed data report rate. After the selected default data report rate matches the at least one fixed data report rate, the data report rate R of the peripheral device 2 is adjusted accordingly.

In an embodiment, the group of plural different default data report rates or the combinations of the group of plural different default data report rates and the group of plural different default DPI values are established in a profile. In addition, the profile is established in the data report rate intelligent adjustment software in a built-in manner or previously set in the data report rate intelligent adjustment software by the user.

Preferably but not exclusively, the key combination is a combination of a DPI key and a right key of a mouse, a combination of a lateral key and a roller key of a mouse, or a combination of a function key and a numeric key of a keyboard.

In an embodiment, while the data report rate intelligent adjustment software generates the dynamic data report rate notification 12 according to the using frequency of at least one application software C1 in the software operating list and/or according to at least one of the peripheral device operating information C21 and the peripheral device input information C22, the hardware performance indication information C31 and the hardware real-time load information C32, the dynamic data report rate notification 12 is generated in several stage. For example, after the data report rate intelligent adjustment software analyzes the using frequency of at least one application software C1 in the software operating list, the peripheral device input information C22 and the hardware performance indication information C31, the dynamic data report rate notification 12 in a first stage is generated. Then, the data report rate intelligent adjustment software generates the dynamic data report rate notification 12 in a second stage according to the actual condition of the hardware real-time load information C32. Since the dynamic data report rate notification 12 can be generated quickly or tuned slowly, the impact on the computer host 1 is reduced.

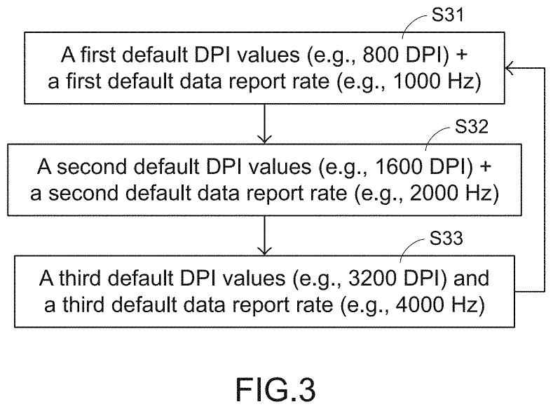

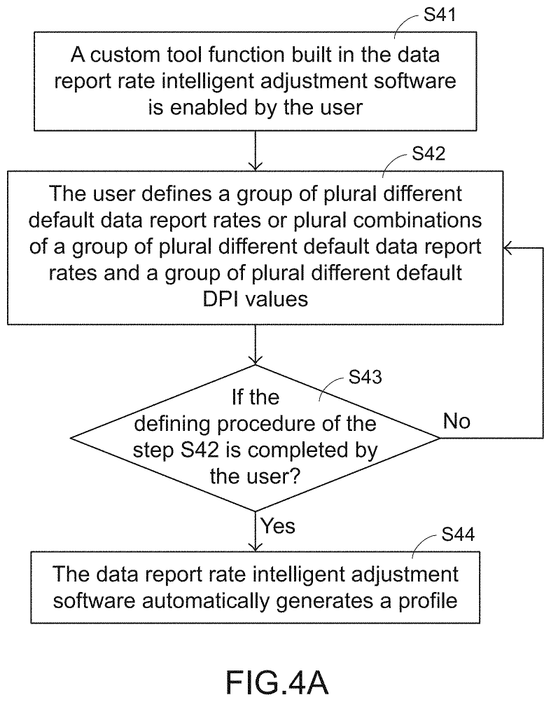

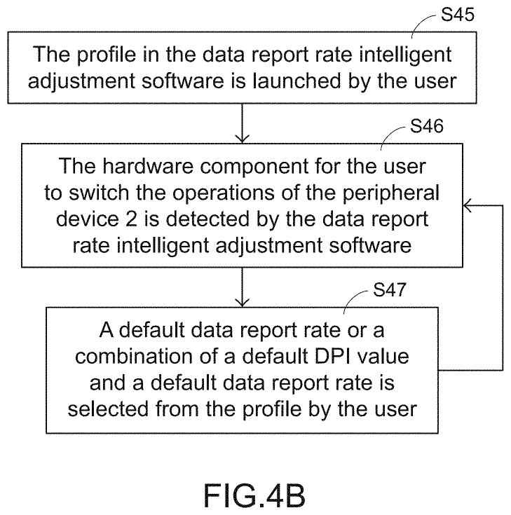

As mentioned above, the group of plural different default data report rates or the combinations of the group of plural different default data report rates and the group of plural different default DPI values are established in a profile, and the profile is established in the data report rate intelligent adjustment software in a built-in manner or previously set in the data report rate intelligent adjustment software by the user. Hereinafter, some implementation examples will be described with reference to FIGS. 3, 4A and 4B.

FIG. 3 illustrates a flowchart of a method for establishing the combinations of three different default data report rates and three different default DPI values in a profile in a built-in manner. By repeatedly pressing down the single key or the key combination, the following steps S31, S32 and S33 are sequentially performed to switch the combinations of a group of three different default data report rates and a group of three different default DPI values in a circulating manner.

In the step S31, the combination of a first default DPI values (e.g., 800 DPI) and a first default data report rate (e.g., 1000 Hz) is selected.

In the step S32, the combination of a second default DPI values (e.g., 1600 DPI) and a second default data report rate (e.g., 2000 Hz) is selected.

In the step S33, the combination of a third default DPI values (e.g., 3200 DPI) and a third default data report rate (e.g., 4000 Hz) is selected.

The steps S31, S32 and S33 are sequentially performed in a circulating manner. Consequently, a suitable profile is provided to the designated data report rate adjustment process in the step S13 of the flowchart of FIGS. 1A and 1B or the dynamic data report rate adjustment process in the step S16 of the flowchart of FIGS. 1A and 1B.

An implementation example of presetting the profile in the data report rate intelligent adjustment software by the user will be described as follows. Consequently, the combinations of a group of three different default data report rates and a group of three different default DPI values are switched in a cyclic manner.

Please refer to FIGS. 4A and 4B. FIG. 4A illustrates a flowchart of a method for presetting the profile in the data report rate intelligent adjustment software by the user. The method at least comprises the following steps.

In a step S41, a custom tool function built in the data report rate intelligent adjustment software is enabled by the user.

In a step S42, the user defines a group of plural different default data report rates or plural combinations of a group of plural different default data report rates and a group of plural different default DPI values. The combinations are restricted to the combinations of the default data report rates and the default DPI values. In some other embodiments, the user may define the combinations of the default data report rates and other function parameters of the peripheral device (e.g., audio sample rates).

In some embodiments, the hardware component to switch the operations of the peripheral device 2 can be self-defined by the user. For example, the type or the content of the single key or the key combination can be self-defined by the user.

After the step S42, a step S43 is performed. In the step S43, the data report rate intelligent adjustment software judges whether the step S42 is completed by the user.

If the data report rate intelligent adjustment software judged that the step S42 is not completed by the user in the step S43, the step S42 is performed again.

If the judging result of the step S42 is completed by the user, a step S44 is performed. In the step S44, the data report rate intelligent adjustment software automatically generates a profile.

After the profile is established by using the flowchart of FIG. 4A, a flowchart of a method for allowing the user to switch the operation of the peripheral device through the profile established by the method of FIG. 4A will be illustrated with reference to FIG. 4B. The method at least comprises the following steps.

In a step S45, the profile in the data report rate intelligent adjustment software is launched by the user.

In a step S46, the hardware component for the user to switch the operations of the peripheral device 2 is detected by the data report rate intelligent adjustment software.

In the step S47, a default data report rate or a combination of a default DPI value and a default data report rate is selected from the profile by the user.

The steps S46 and S47 are sequentially performed in a circulating manner.

From the above descriptions, the present invention provides an intelligent data report rate adjustment method. According to the actual workload level and the hardware operating performance of the computer host and/or the information about the built-in application software, the data report rate is intelligently or dynamically adjusted according to the built-in default value or the user-defined value. Consequently, the computer host can flexibly and effectively meet the speed requirements of various data report rates of the peripheral devices. In addition, the reduce unnecessary data report transmission can be avoided. Since the power consumption of the peripheral device and/or the computer host is reduced, the power-saving efficacy is enhanced. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A data report rate adjustment method for use between a computer host and a peripheral device, the data report rate adjustment method at least comprising steps of:
(a) judging whether a content of a software operating list is launched and served as a criterion for adjusting a data report rate of the peripheral device;
(b) if a judging result of the step (a) indicates that the content of the software operating list is launched and served as the criterion for adjusting the data report rate of the peripheral device, judging whether a designated data report rate notification is generated according to an information of at least one application software in the software operating list and served as the criterion for adjusting the data report rate of the peripheral device;
(c) generating the designated data report rate notification according to the information of at least one application software in the software operating list, performing a designated data report rate adjustment process according to the designated data report rate notification, and performing the step (a) again;
(d) if the judging result of the step (a) indicates that the content of the software operating list is not launched or a judging result of the step (b) indicates that the designated data report rate notification is not generated to be served as the criterion for adjusting the data report rate of the peripheral device, automatically collecting at least one of a peripheral device operating information, a peripheral device input information, a hardware performance indication information and a hardware real-time load information; and
(e) generating a dynamic data report rate notification according to a frequency of using the at least one application software in the software operating list by a user and/or according to at least one of the peripheral device operating information and the peripheral device input information, the hardware performance indication information and the hardware real-time load information, performing a dynamic data report rate adjustment process according to the dynamic data report rate notification, and performing the step (a) again.

2. The data report rate adjustment method according to claim 1, wherein in the step (a), the content of the software operating list contains the information of the at least one application software that in installed in the computer host and operated and used through the peripheral device.

3. The data report rate adjustment method according to claim 2, wherein in the step (b), the designated data report rate notification is previously set in the software operating list according to a function property of the at least one application software, and the designated data report rate notification is related to at least one fixed data report rate corresponding to the at least one application software.

4. The data report rate adjustment method according to claim 1, wherein while the designated data report rate adjustment process in the step (c) is performed, the designated data report rate notification is transmitted from the computer host to the peripheral device and the data report rate of the peripheral device is adjusted automatically according to the designated data report rate notification, or the computer host generates the designated data report rate notification to prompt the user and the user manually adjusts the data report rate of the peripheral device according to the designated data report rate notification.

5. The data report rate adjustment method according to claim 4, wherein the data report rate of the peripheral device is manually adjusted by the user through a single key or a key combination of the peripheral device in response to the designated data report rate notification, wherein the single key or the key combination is manually and repeatedly pressed to switch a group of plural different default data report rates until one of the plural default data report rate is selected, or the single key or the key combination is manually and repeatedly pressed to switch plural combinations of the group of plural different default data report rates and a group of plural different default dots per linear inch (DPI) values until one of the plural combinations of the group of plural different default data report rates and the group of plural different default DPI values is selected, wherein the key combination is a combination of a DPI key and a right key of a mouse, a combination of a lateral key and a roller key of a mouse, or a combination of a function key and a numeric key of a keyboard.

6. The data report rate adjustment method according to claim 1, wherein while the dynamic data report rate adjustment process in the step (e) is performed, the dynamic data report rate notification is transmitted from the computer host to the peripheral device and the data report rate of the peripheral device is adjusted automatically according to the dynamic data report rate notification, or the computer host generates the dynamic data report rate notification to prompt the user and the user manually adjusts the data report rate of the peripheral device according to the dynamic data report rate notification.

7. The data report rate adjustment method according to claim 6, wherein the data report rate of the peripheral device is manually adjusted by the user through a single key or a key combination of the peripheral device in response to the dynamic data report rate notification, wherein the single key or the key combination is manually and repeatedly pressed to switch a group of plural different default data report rates until one of the plural default data report rate is selected, or the single key or the key combination is manually and repeatedly pressed to switch plural combinations of the group of plural different default data report rates and a group of plural different default dots per linear inch (DPI) values until one of the plural combinations of the group of plural different default data report rates and the group of plural different default DPI values is selected, wherein the key combination is a combination of a DPI key and a right key of a mouse, a combination of a lateral key and a roller key of a mouse, or a combination of a function key and a numeric key of a keyboard.

8. The data report rate adjustment method according to claim 1, wherein in the step (d), the peripheral device operating information is an operating habit information related to a habit of the user to operate the peripheral device and at least contains a frequently-used key information and an operating time information, or the peripheral device input information is an input data information related to the peripheral device and contains at least one of a key data input data information, a sensor data input information, a roller movement data input information and a lighting effect data input information, or the hardware performance indication information is related to a hardware component score of the computer host and contains at least one of a central processing unit (CPU) clock speed score, a memory capacity score, a solid state drive (SSD) capacity score and a hardware accelerator card score, or the hardware real-time load information is related to a workload level of the central processing unit of the computer host in a real-time operation.

9. The data report rate adjustment method according to claim 1, wherein after the data report rate of the peripheral device has been adjusted in the step (c) or the step (e), an information of the adjusted data report rate is transmitted from the peripheral device to the computer host and a specified notification message is provided to notify the user, and then the computer host performs the step (a) again.

10. The data report rate adjustment method according to claim 9, wherein the specified notification message is a text message shown in an on-screen display (OSD) manner, a light effect message generated in a light emitting diode (LED) display manner, an/or a sound effect notification message.

11. The data report rate adjustment method according to claim 1, wherein a data report rate intelligent adjustment software is installed in the computer host, and the data report rate intelligent adjustment software works with the computer host and a microprocessor of the peripheral device to implement the step (a), the step (b), the step (c), the step (d) and the step (e).

12. The data report rate adjustment method according to claim 11, wherein the data report rate intelligent adjustment software at least contains the software operating list and a profile, which are established in the data report rate intelligent adjustment software in a built-in manner or previously set in the data report rate intelligent adjustment software by the user, wherein the profile at least contains a group of plural different default data report rates, or the profile at least contains plural combinations of the group of plural different default data report rates and a group of plural different default dots per linear inch (DPI) values.

13. The data report rate adjustment method according to claim 12, wherein the data report rate intelligent adjustment software detects operation status or system configuration statuses of the computer host and the peripheral device to collect at least one of the peripheral device operating information, the peripheral device input information, the hardware performance indication information and the hardware real-time load information.
